(19) United States
(12) Patent Application Publication
(10) Pub. No.: US 2017/0166104 A1
(43) Pub. Date: Jun. 15, 2017

(54) LEVEL ADJUSTING SLEEPER BED DEVICE

(71) Applicant: Jenna Gilmore, Las Vegas, NV (US)

(72) Inventor: Jenna Gilmore, Las Vegas, NV (US)

(21) Appl. No.: 14/964,262

(22) Filed: Dec. 9, 2015

(51) Int. Cl. B60P 3/39; A47C 19/04; A47C 17/80

(52) U.S. Cl. CPC B60P 3/39; A47C 17/80; A47C 19/045

(57) ABSTRACT

A level adjusting sleeper bed device for leveling a sleeper bed includes a shell that is semi rigid, air tight and cuneal. A plurality of ports is positioned in the shell. A plurality of stiffeners that is rigid and elongated rectangularly shaped is reversibly couplable to a top of the shell. The shell is configured to be placed beneath a mattress of a sleeper bed. The ports are configured to add air to the shell, raising a first end of the shell relative to a second end of the shell, such that the mattress can be leveled. The stiffeners are positioned on the shell to support the mattress. The ports are configured to release the air from the shell as required by repositioning of the semi-trailer.

### BACKGROUND OF THE DISCLOSURE

Field of the Disclosure

The disclosure relates to sleeper bed devices and more particularly pertains to a new sleeper bed device for leveling a sleeper bed.

### SUMMARY OF THE DISCLOSURE

An embodiment of the disclosure meets the needs presented above by generally comprising a shell that is semi rigid, air tight and cuneal. A plurality of ports is positioned in the shell. A plurality of stiffeners that is rigid and elongated rectangularly shaped is reversibly couplable to a top of the shell. The shell is configured to be placed beneath a mattress of a sleeper bed. The ports are configured to add air to the shell, raising a first end of the shell relative to a second end of the shell, such that the mattress can be leveled. The stiffeners are positioned on the shell to support the mattress. The ports are configured to release the air from the shell as required by repositioning of the semi-trailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a level adjusting sleeper bed device according to an embodiment of the disclosure.

FIG. 2 is a side view of an embodiment of the disclosure.

FIG. 3 is a front view of an embodiment of the disclosure.

FIG. 4 is a top view of an embodiment of the disclosure.

FIG. 5 is an in-use view of an embodiment of the disclosure.

### DESCRIPTION OF THE PREFERRED EMBODIMENT

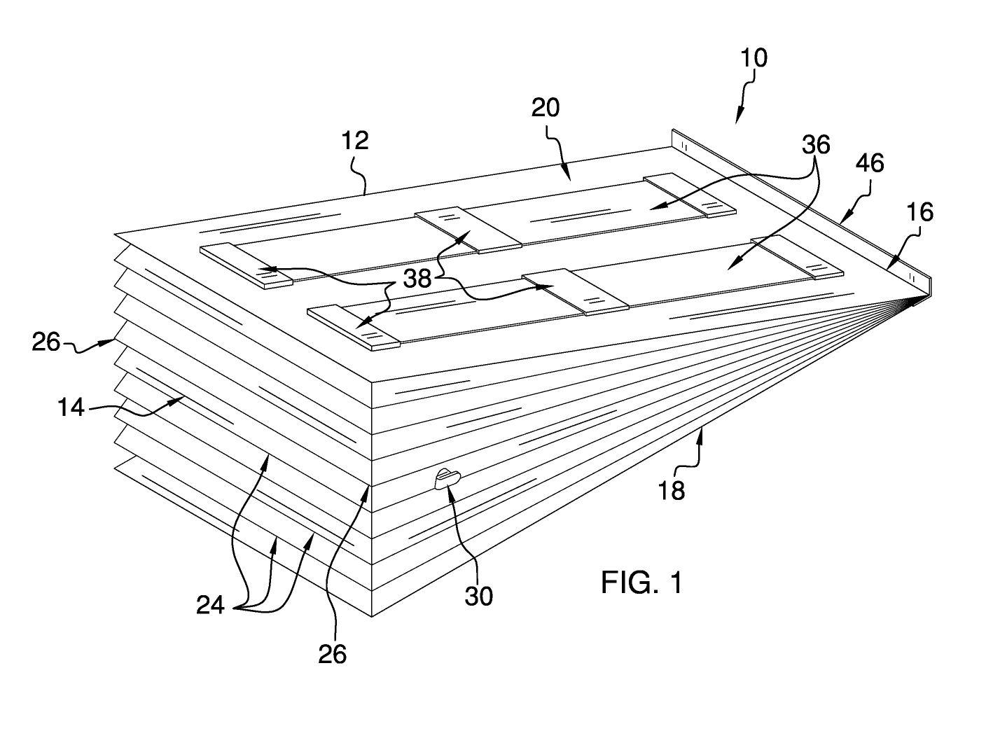

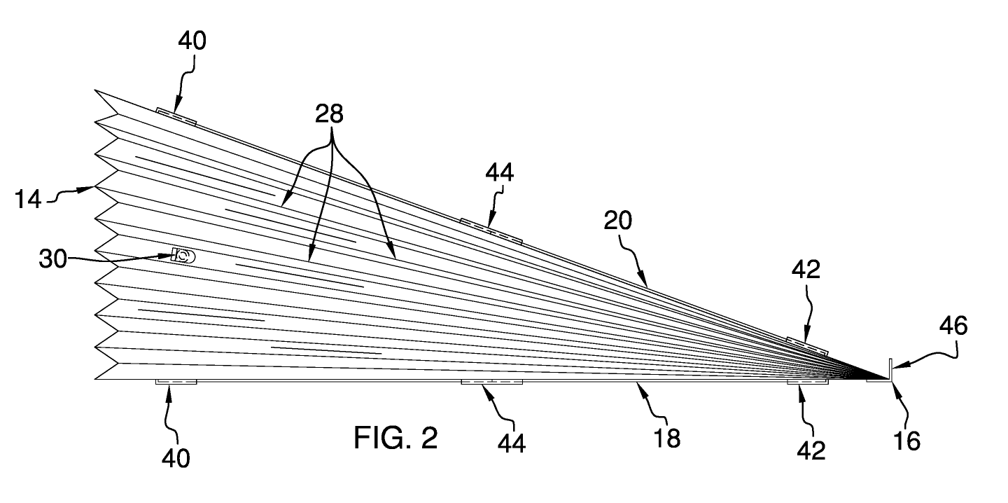

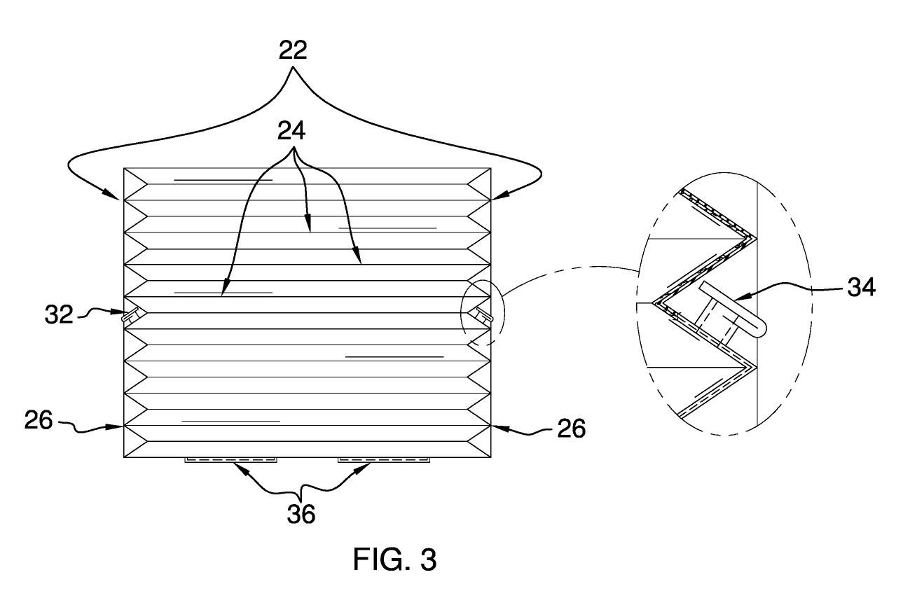

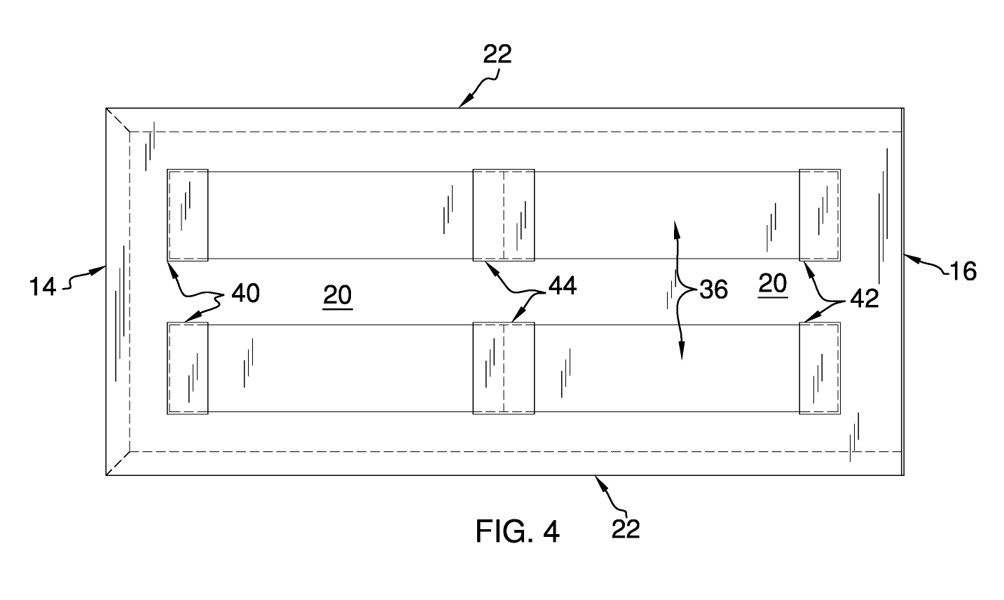

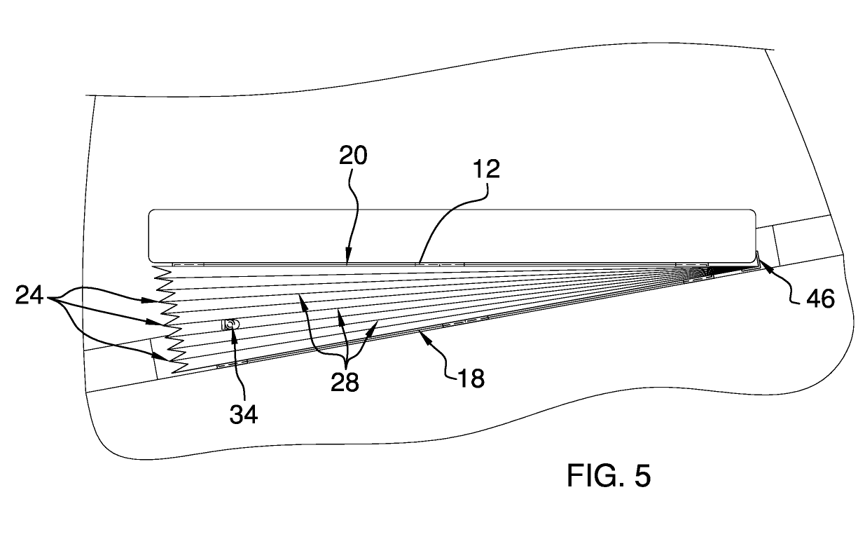

With reference now to the drawings, and in particular to FIGS. 1 through 5 thereof, a new sleeper bed device embodying the principles and concepts of an embodiment of the disclosure and generally designated by the reference numeral 10 will be described.

As best illustrated in FIGS. 1 through 5, the level adjusting sleeper bed device 10 generally comprises a shell 12 that is semi rigid, air tight and cuneal. The shell 12 has a first end 14, a second end 16, a bottom 18, a top 20, and a pair of opposing sides 22. The top 20, the bottom 18 and the first end 14 are substantially rectangular. The opposing sides 22 are triangular. The shell 12 is sized such that the top 20 is substantially dimensionally equivalent to the sleeper bed of a semi-trailer. Preferably, the shell 12 comprises rubberized canvas.

The first end 14 comprises a plurality of first pleats 24. Each first pleat 24 has opposing ends 26. Each first pleat 24 extends between the opposing sides 22 of the shell 12. The opposing sides 22 comprise a plurality of second pleats 28. Each second pleat 28 extends from a respective opposing end 26 of a respective first pleat 24 to the second end 16. Each second pleat 28 is dimensionally wider at the first end 14 relative to the second end 16, such that each second pleat 28 is tapered.

A plurality of ports 30 is positioned in the shell 12 and configured for air addition to and air release from the shell 12. The plurality of ports 30 comprises compressed air valves 32. Preferably, the plurality of ports 30 comprises Schrader valves 34. Also preferably, the plurality of ports 30 comprises two ports 30 positioned one each in the opposing sides 22 of the shell 12, such that a respective port 30 is accessible for addition of air to the shell 12 when the shell 12 is positioned under the mattress.

A plurality of stiffeners 36 that is flat, rigid and elongated rectangularly shaped is reversibly couplable to the top 20 of the shell 12. The stiffeners 36 are configured to support the mattress of the sleeper bed. Preferably, respective stiffeners 36 are reversibly couplable to the top 20 and respective stiffeners 36 are reversibly couplable to the bottom 18. Preferably, the stiffeners 36 are wooden.

The device 10 comprises a plurality of fasteners 38. Respective fasteners 38 are coupled to the top 20 and positioned to reversibly couple a respective stiffener 36 to the top 20. Preferably, respective fasteners 38 also are coupled to the bottom 18 and positioned to reversibly couple a respective stiffener 36 to the bottom 18. The plurality of fasteners 38 may comprise first pockets 40 and second pockets 42. The first pockets 40 are positioned proximate to the first end 14, and the second pockets 42 are positioned proximate to the second end 16. A respective first pocket 40 and a respective second pocket 42 are positioned to reversibly couple a respective stiffener 36 to the shell 12. The plurality of fasteners 38 also may comprise sleeves 44. Each sleeve 44 is positioned between a respective first pocket 40 and a respective second pocket 42, such that a respective stiffener 36 is positionable through the sleeve 44 and into the respective first pocket 40 and the respective second pocket 42.

A foot support 46 is coupled to the shell 12 adjacent to the second end 16. The foot support 46 extends between the opposing sides 22. The foot support 46 extends transversely upward from the top 20 of the shell 12. The foot support 46 is L-shaped when viewed longitudinally.

In use, the shell 12 is configured to be placed beneath the mattress of a sleeper bed. The ports 30 are configured for addition of air to the shell 12, such that the first end 14 of the shell 12 is raised relative to the second end 16 of the shell 12, wherein the mattress can be leveled. The stiffeners 36 are positioned on the shell 12 to support the mattress. The ports 30 are configured to release the air from the shell 12 as required by repositioning of the semi-trailer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A level adjusting sleeper bed device comprising:
a shell, said shell being semi rigid, said shell being air tight, said shell being cuneal, said shell having a first end and a second end;
a plurality of ports, said ports being positioned in said shell, said ports being configured for air addition to and air release from said shell;
a plurality of stiffeners, said stiffeners being flat, rigid and elongated rectangularly shaped, said stiffeners being reversibly couplable to said top of said shell, wherein said stiffeners are configure to support the mattress of the sleeper bed; and
wherein said shell is configured for placement beneath the mattress of a sleeper bed, wherein said ports are configured for addition of air to said shell, wherein said first end of said shell is raised relative to said second end of said shell, such that the mattress can be leveled, wherein said stiffeners are positioned on said shell to support the mattress, and wherein said ports are configured to release the air from said shell as required by repositioning of the semi-trailer.

2. The device of claim 1, further comprising:
said shell having a bottom, a top, and a pair of opposing sides; and
said top, said bottom and said first end being substantially rectangular, said opposing sides being triangular.

3. The device of claim 1, further including said shell being sized such that said top is substantially dimensionally equivalent to the sleeper bed of a semi-trailer.

4. The device of claim 2, further comprising:
said first end comprising a plurality of first pleats, each said first pleat having opposing ends, each said first pleat extending between said opposing sides; and
said opposing sides comprising a plurality of second pleats, each said second pleat extending from a respective said opposing end of a respective said first pleat to said second end, each said second pleat being dimensionally wider at said first end relative to said second end, such that each said second pleat is tapered.

5. The device of claim 1, further including said shell comprising rubberized canvas.

6. The device of claim 1, further including said plurality of ports comprising compressed air valves.

7. The device of claim 6, further including said plurality of ports comprising Schrader valves.

8. The device of claim 1, further including said plurality of ports comprising two ports, each said port being positioned in a respective said opposing side of said shell, such that a respective said port is accessible for addition of air to said shell when said shell is positioned under the mattress.

9. The device of claim 2, further comprising:
respective said stiffeners being reversibly couplable to said top; and
respective said stiffeners being reversibly couplable to said bottom.

10. The device of claim 1, further including said stiffeners being wooden.

11. The device of claim 2, further including a plurality of fasteners, respective said fasteners being coupled to said top and positioned to reversibly couple a respective said stiffener to said top.

12. The device of claim 11, further including respective said fasteners being coupled to said bottom and positioned to reversibly couple a respective said stiffener to said bottom.

13. The device of claim 11, further including said plurality of fasteners comprising first pockets and second pockets, said first pockets being positioned proximate to said first end, said second pockets being positioned proximate to said second end, such that a respective said first pocket and a respective said second pocket are positioned to reversibly couple a respective said stiffener to said shell.

14. The device of claim 13, further including said plurality of fasteners comprising sleeves, each said sleeve being positioned between a respective said first pocket and a respective said second pocket, wherein a respective said stiffener is positionable through said sleeve and into said respective said first pocket and said respective said second pocket.

15. The device of claim 2, further including a foot support, said foot support being coupled to said shell adjacent to said second end, said foot support extending between said opposing sides, said foot support extending transversely upward from said top of said shell.

16. The device of claim 15, further including said foot support being L-shaped when viewed longitudinally.

17. A level adjusting sleeper bed device comprising:
a shell, said shell being semi rigid, said shell being air tight, said shell being cuneal, said shell having a first end, a second end, a bottom, a top, and a pair of opposing sides;
said top, said bottom and said first end being substantially rectangular, said opposing sides being triangular;
said shell being sized such that said top is substantially dimensionally equivalent to the sleeper bed of a semi-trailer, said shell comprising rubberized canvas;
said first end comprising a plurality of first pleats, each said first pleat having opposing ends, each said first pleat extending between said opposing sides;
said opposing sides comprising a plurality of second pleats, each said second pleat extending from a respective said opposing end of a respective said first pleat to said second end, each said second pleat being dimensionally wider at said first end relative to said second end, such that each said second pleat is tapered;
a plurality of ports, said ports being positioned in said shell, said ports being configured for air addition to and air release from said shell, said plurality of ports comprising compressed air valves, said plurality of ports comprising Schrader valves, said plurality of ports comprising two ports, each said port being positioned in a respective said opposing side of said shell, such that a respective said port is accessible for addition of air to said shell when said shell is positioned under the mattress;
a plurality of stiffeners, said stiffeners being flat, rigid and elongated rectangularly shaped, said stiffeners being reversibly couplable to said top of said shell, wherein said stiffeners are configure to support the mattress of the sleeper bed, respective said stiffeners being reversibly couplable to said top and respective said stiffeners being reversibly couplable to said bottom, said stiffeners being wooden;
a plurality of fasteners, respective said fasteners being coupled to said top and positioned to reversibly couple a respective said stiffener to said top, respective said fasteners being coupled to said bottom and positioned to reversibly couple a respective said stiffener to said bottom;
said plurality of fasteners comprising first pockets and second pockets, said first pockets being positioned proximate to said first end, said second pockets being positioned proximate to said second end, such that a respective said first pocket and a respective said second pocket are positioned to reversibly couple a respective said stiffener to said shell;
said plurality of fasteners comprising sleeves, each said sleeve being positioned between a respective said first pocket and a respective said second pocket, wherein a respective said stiffener is positionable through said sleeve and into said respective said first pocket and said respective said second pocket;
a foot support, said foot support being coupled to said shell adjacent to said second end, said foot support extending between said opposing sides, said foot support extending transversely upward from said top of said shell, said foot support being L-shaped when viewed longitudinally; and
wherein said shell is configured for placement beneath the mattress of a sleeper bed, wherein said ports are configured for addition of air to said shell, wherein said first end of said shell is raised relative to said second end of said shell, wherein the mattress can be leveled, wherein said stiffeners are positioned on said shell to support the mattress, and wherein said ports are configured to release the air from said shell as required by repositioning of the semi-trailer.
